(19) United States
(12) Patent Application Publication
(10) Pub. No.: US 2005/0257942 A1
(43) Pub. Date: Nov. 24, 2005

(54) Air intake control structure for pneumatic tool

(75) Inventor: Ching-Shun Chang, Taichung (TW)

Correspondence Address: BACON & THOMAS, PLLC, 625 SLATERS LANE, FOURTH FLOOR, ALEXANDRIA, VA, 22314, US

(73) Assignee: Hsiu-Ju Chen, Taichung (TW)

(21) Appl. No.: 11/126,240

(22) Filed: May 11, 2005

(30) Foreign Application Priority Data
May 21, 2004 (TW) 93208054

(51) Int. Cl. B25D 9/00

(52) U.S. Cl. 173/104; 173/169

(57) ABSTRACT

An air intake control structure used in a pneumatic tool and coupled to an impact unit is disclosed to include a tool body, which has an accommodating chamber and an air inlet in air communication with the accommodating chamber, a sliding barrel, which holds the impact unit in the accommodating chamber and is movable between a first position and a second position and has a stop flange extending around the periphery, a damper unit for buffering relative movement between the sliding barrel and the tool body, and an air control device, which is mounted in the air inlet of the tool body for blocking the air intake when the sliding barrel is moved to the first position or opening the air inlet for letting a compressed air pass through the air inlet to move the impact unit when the sliding barrel is moved to the second position.

### BACKGROUND OF THE INVENTION

1. Field of the Invention

The present invention relates to a pneumatic tool and more particularly, to an air intake control structure for pneumatic tool.

2. Description of the Related Art

In a conventional pneumatic tool, more particularly, a reciprocating type pneumatic tool, the vibration produced by the impact unit may cause damage to the internal parts or injure the operator if the impact unit is stopped against the workpiece during its operation.

There are commercially available pneumatic tools that have means to prevent idle running. However, these designs are commonly complicated, resulting in a high manufacturing cost. There are also known simple designs of pneumatic tools, however these simple designs of pneumatic tools cannot effectively prevent idle running.

### SUMMARY OF THE INVENTION

The present invention has been accomplished under the circumstances in view. It is the main object of the present invention to provide an air intake control structure for pneumatic tool that controls intake of air rapidly and accurately, preventing idle running. It is another object of the present invention to provide an air intake control structure for pneumatic tool that has a simple structure convenient for assembly and practical for durable use.

To achieve these and other objects of the present invention, the air intake control structure is used in a pneumatic tool and coupled to an impact unit, comprising a tool body, the tool body comprising a mounting portion, an accommodating chamber defined in the mounting portion, and an air inlet in air communication with the accommodating chamber; a sliding barrel adapted to accommodate the impact unit, the sliding barrel comprising a barrel body mounted in the accommodating chamber of the tool body in an airtight status and movable between a first position and a second position, and a stop flange extending around the periphery of the barrel body; a damper unit adapted to buffer movement between the sliding barrel and the tool body; and an air control device, the air control device comprising a plug mounted in the air inlet of the tool body and adapted to block the air intake when the sliding barrel is moved to the first position, and to open the air inlet for letting a compressed air pass through the air inlet to move the impact unit when the sliding barrel is moved to the second position.

### BRIEF DESCRIPTION OF THE DRAWINGS

FIG. 1 is a sectional assembly view of an air intake control structure according to the present invention.

FIG. 2 is an exploded view in section in an enlarged scale of a part of the air intake control structure according to the present invention.

FIG. 3 is an enlarged view of a part of FIG. 1, showing the structure of the air control device.

FIG. 4 is a sectional view taken along line 4-4 of FIG. 3.

FIG. 5 corresponds to FIG. 4, showing the stop flange of the sliding barrel moved to the second position.

FIG. 6a is a sectional view showing an alternate form of the air control device according to the present invention.

FIG. 6b is a sectional view showing another alternate form of the air control device according to the present invention.

FIG. 7 is a sectional view showing still another alternate form of the air control device according to the present invention.

FIG. 8a is a sectional view showing still another alternate form of the air control device according to the present invention.

FIG. 8b is a sectional view showing still another alternate form of the air control device according to the present invention.

FIG. 9a is a sectional view showing still another alternate form of the air control device according to the present invention.

FIG. 9b corresponds to FIG. 9a, showing the sliding barrel moved to the second position, the air control device stopped at the beveled face of the stop flange of the sliding barrel.

FIG. 10 is a sectional view showing still another alternate form of the air control device according to the present invention.

FIG. 11a is a sectional view showing still another alternate form of the air control device according to the present invention.

FIG. 11b corresponds to FIG. 11a, showing the air control device elastically deformed.

FIG. 12 is a sectional view showing an annular form of the air control device according to the present invention.

FIG. 13 is a sectional view showing a spherical form of the air control device according to the present invention.

FIG. 14 is a sectional view showing an air groove formed in the sliding barrel according to the present invention.

### DETAILED DESCRIPTION OF THE INVENTION

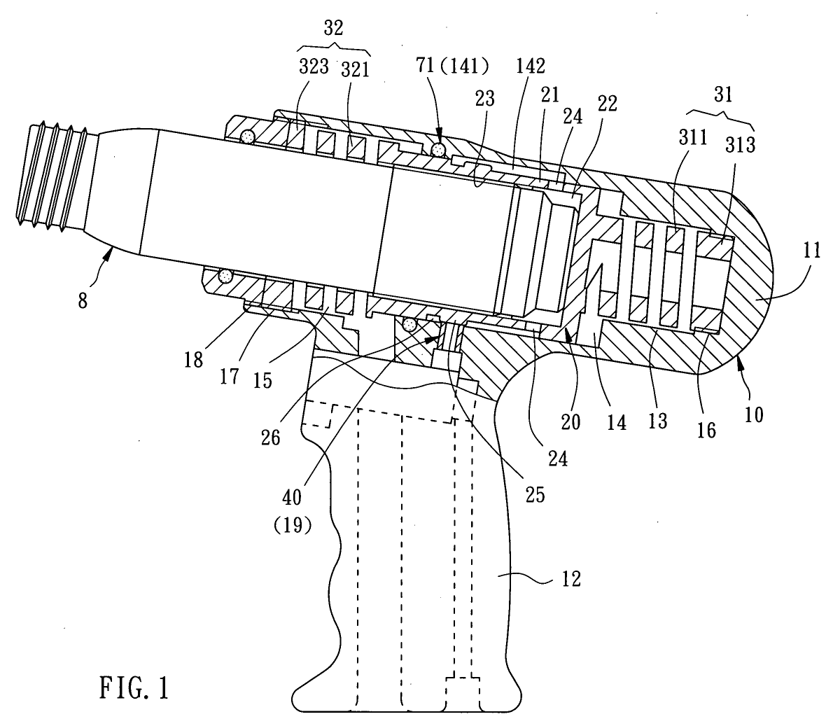

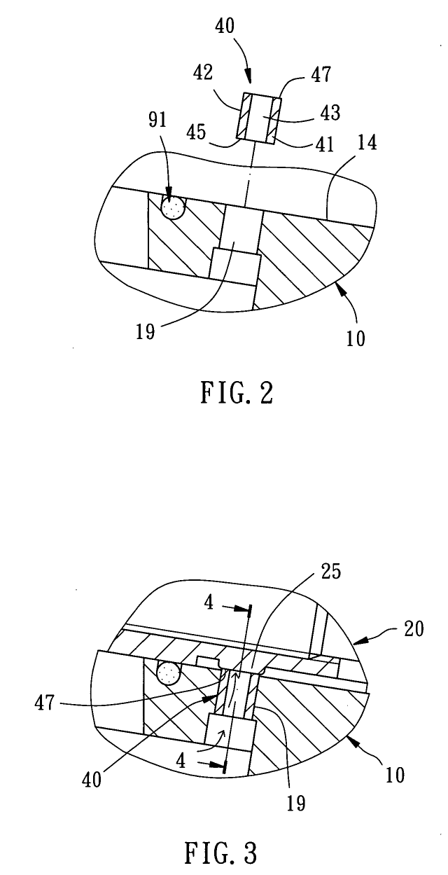

Referring to FIGS. 1 and 2, an air intake control structure for pneumatic tool is coupled to an impact unit 8, comprising a tool body 10, a sliding barrel 20, a damper unit 30, and an air control device 40.

The tool body 10 comprises a mounting portion 11, a handle 12 connected to the mounting portion 11, a first bearing hole 13 and an accommodating chamber 14 and a second bearing hole 15 formed in proper order in the mounting portion 11, a seal ring groove 141 and an air groove 142 respectively extending around the inside wall of the mounting portion 11 within the accommodating chamber 14, a first locating means (for example, a screw hole) 16 disposed at one end of the first bearing hole 13, a second locating means 17 and a positioning means 18 (both the second locating means 17 and the positioning means 18 form a screw hole) disposed near the orifice of the second bearing hole 15, and an air inlet 19 formed in the handle 12 and extending to the accommodating chamber 14. Further, a seal ring 71 is mounted in the seal ring groove 141 inside the tool body 10.

The sliding barrel 20 comprises a barrel body 21 axially slidably inserted into the accommodating chamber 14 and peripherally surrounded by the seal ring 71 to prevent leakage of air, an air chamber 22 defined within the barrel body 21, an inner thread 23 formed in the air chamber 22 inside the barrel body 21 for receiving the impact unit 8, a plurality of air holes 24 in air communication between the air chamber 22 and the air groove 142 of the tool body 10, a stop flange 25 extending around the periphery of the barrel body 21, and an air groove 26 extending around the periphery of the barrel body 21 adjacent to the stop flange 25. The air holes 24 and air groove 26 of the sliding barrel 20 are in air communication with the air groove 142 of the tool body 10.

The damper unit 30 comprises a first damper 31 and a second damper 32. The first and second dampers 31 and 32 each comprise a damping coil 311 or 321 respectively mounted on the barrel body 21 of the sliding barrel 20 near the two distal ends thereof, and a locating means 313 or 323 extended from the respective damping coil 311 or 321 and respectively fastened to the first locating means 16 and second locating means 17 of the tool body 10.

The air control device 40 comprises a cylindrical plug 41 inserted into the air inlet 19 of the tool body 10, a sealing flange 42 formed integral with the peripheral wall of the cylindrical plug 41, an air hole 43 axially extending through the two distal ends of the cylindrical plug 41, a stop portion 45 facing the compressed air source, and a sealing portion 47 for stopping against the stop flange 25 of the sliding barrel 20.

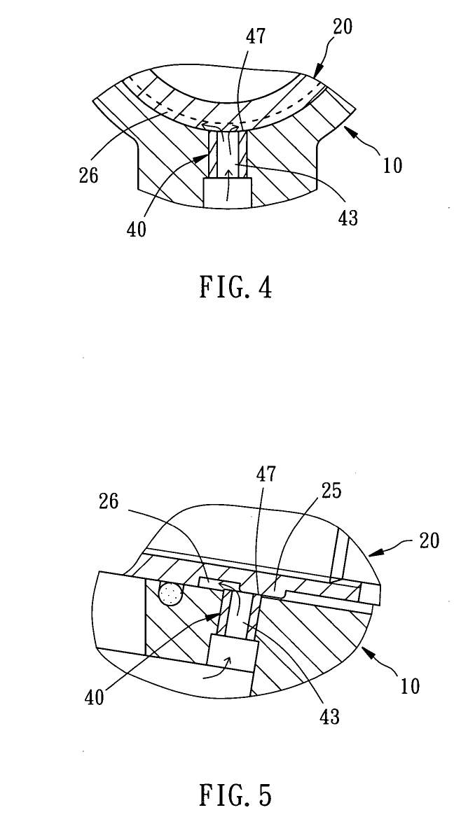

The operation of the present invention is outlined hereinafter. When pressed the press-button switch (not shown), compressed air is allowed to pass to the air inlet 19 of the tool body 10 and the air control device 40 to push the air control device 40 upwards, thereby forcing the sealing portion 47 against the stop flange 25 of the sliding barrel 20 and the sealing flange 42 against the peripheral wall of the air inlet 19, and therefore the air inlet 19 is blocked and the impact unit 8 does no work. At this time, the stop flange 25 of the sliding barrel 20 is in the first position as shown in FIGS. 3 and 4.

When wishing to reciprocate the impact unit 8, press the tip (front end) of the impact unit 8 against the workpiece to overcome the spring force of the damper unit 30 and to further force the sliding barrel 20 backwards, having the stop flange 25 of the sliding barrel 20 moved to the second position as shown in FIG. 5. At this time, the stop flange 25 of the sliding barrel 20 is spaced from the air hole 43 of the air control device 40, allowing compressed air to pass through the air groove 142 of the tool body 10 and the air holes 24 of the sliding barrel 20 to the impact unit 8. Therefore, the internal parts of the impact unit 8 are forced by the compressed air to reciprocate the sliding barrel. At this time, the damper unit 30 provides a shock absorbing effect. Immediately after the operator moved the tip of the impact unit 8 away from the workpiece, the sliding barrel 20 returns to the second position, and the impact unit 8 is stopped.

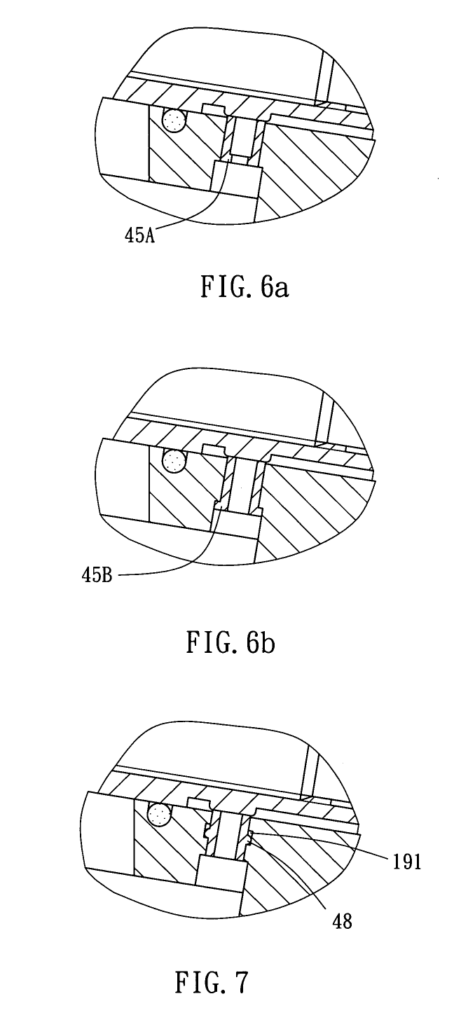

The air control device and the matching parts may be variously embodied. For example, the stop portion 45A of the embodiment shown in FIG. 6a or the stop portion 45B of the embodiment shown in FIG. 6b has a relatively greater wind bearing area so that the air control device can receive more pressure from compressed air to enhance the airtight status.

The air control device of the embodiment shown in FIG. 7 has a positioning portion 48 positioned in a positioning portion 191 inside the tool body.

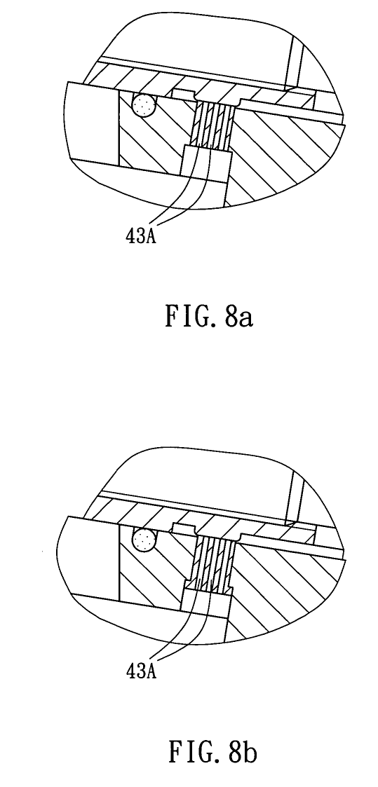

The air control device of the embodiment shown in FIG. 8a or the air control device of the embodiment shown in FIG. 8b has multiple air holes 43A extending through the two distal ends and arranged in parallel. According to these two designs, the cylindrical plug of the air control device has a relatively stronger structural strength and allows passing of compressed air efficiently.

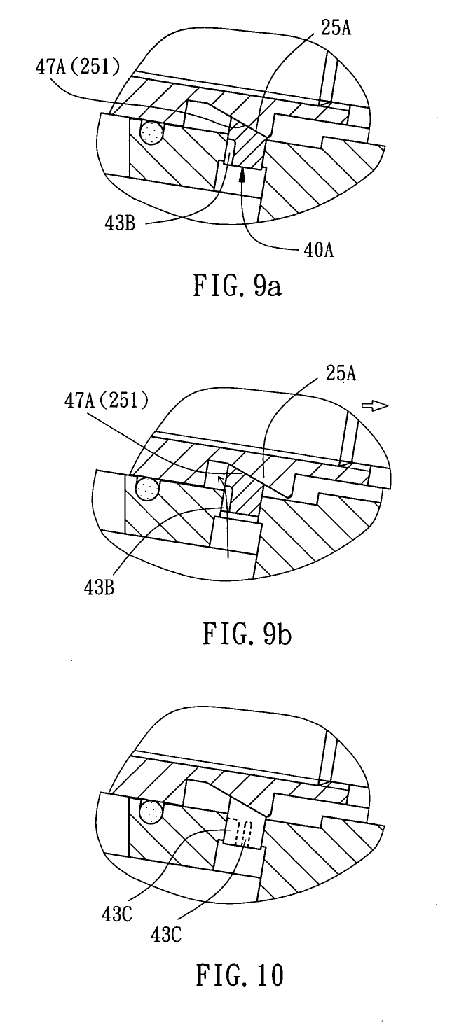

The stop flange 25A of the sliding barrel according to the embodiment shown in FIGS. 9a and 9b has a beveled face 251; the sealing portion 47A of the air control device 40A according to the embodiment shown in FIGS. 9a and 9b has a beveled face fitting the beveled face 251 of the stop flange 25A of the sliding barrel, and the air hole 43B of the air control device 40A extends upwards and then curved to the periphery. When the sliding barrel is moved to the second position, the air control device 40A is stopped at the beveled face 251 of the stop flange 25A of the sliding barrel, allowing compressed air to pass through the air hole 43B of the air control device 40A.

According to the embodiment shown in FIG. 10, the air control device has multiple air holes 43C.

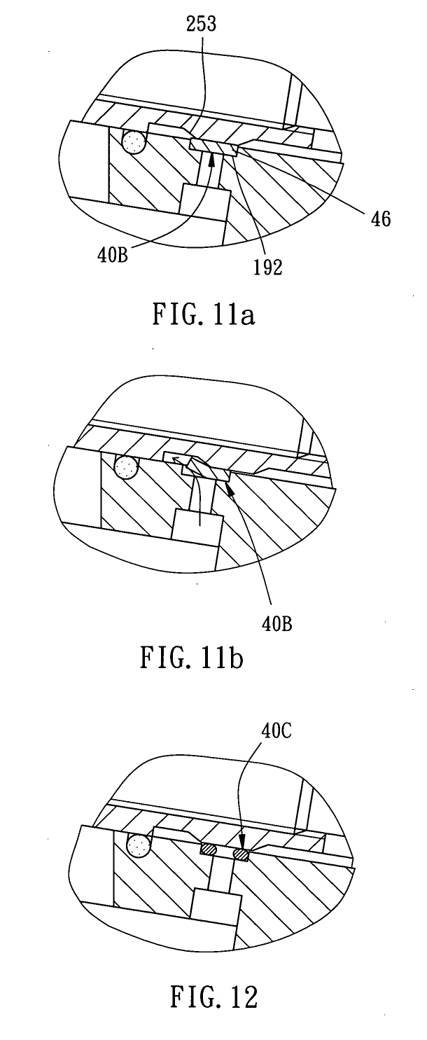

According to the embodiment shown in FIGS. 11a and 11b, the tool body further comprises a female locating portion 192; the sliding barrel has a second beveled face 253; the air control device 40B has a male locating portion 46 coupled to the locating portion 192 of the female locating portion 192; when the sliding barrel is moved to the second position, the plug of the air control device is not pressed by the stop flange of the sliding barrel but can be elastically deformed by compressed air for letting compressed air to pass.

According to the embodiment shown in FIG. 12, the air control device 40C has an annular profile.

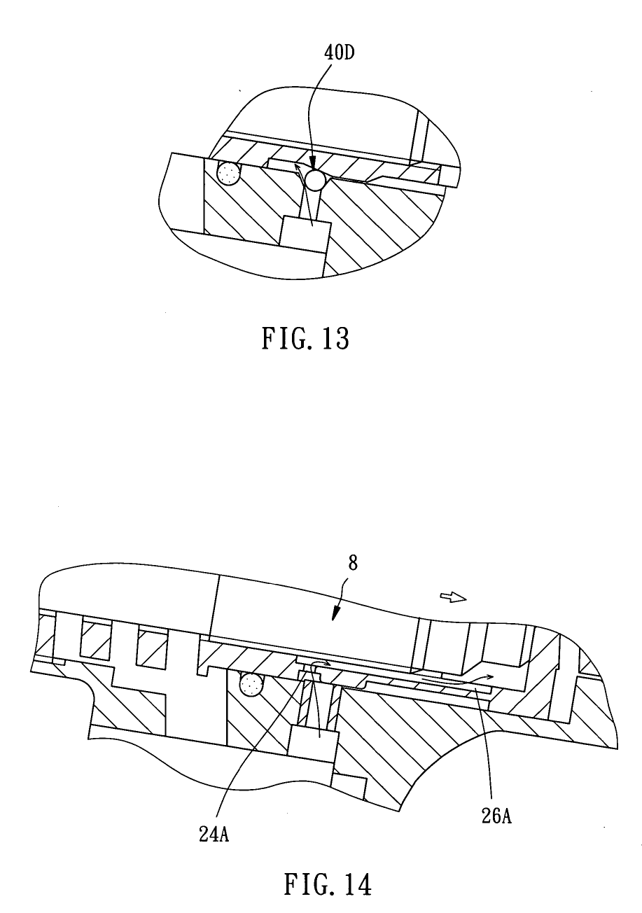

According to the embodiment shown in FIG. 13, the air control device 40D has a spherical profile.

According to the embodiment shown in FIG. 14, the air holes 24A of the sliding barrel are provided at the other side, and an air groove 26A is formed in the screw hole of the sliding barrel for guiding compressed air from the air holes 24A to the impact unit 8 for reciprocating motion.

As indicated above, the contour of the axial cross section of the air control device can be made having a circular shape, T-shape, L-shape, trapezoidal shape, rectangular shape, spherical shape, or annular shape.

Further, the contour of the top side of the transverse cross section of the air control device can be made having an arched, straight, convex, or corrugated shape.

In general, the invention provides an air intake control structure for pneumatic tool, which has the following features:

1. The air intake control structure controls intake of air rapidly and accurately, preventing idle running.

2. The air intake control structure has a simple structure convenient for assembly and practical for durable use.

Although particular embodiments of the invention have been described in detail for purposes of illustration, various modifications and enhancements may be made without departing from the spirit and scope of the invention. Accordingly, the invention is not to be limited except as by the appended claims

1. An air intake control structure used in a pneumatic tool and coupled to an impact unit, comprising:
a tool body, said tool body comprising a mounting portion, an accommodating chamber defined in said mounting portion, and an air inlet in air communication with said accommodating chamber;
a sliding barrel adapted to accommodate said impact unit, said sliding barrel comprising a barrel body mounted in said accommodating chamber of said tool body in an airtight status and movable between a first position and a second position, and a stop flange extending around the periphery of said barrel body;
a damper unit adapted to buffer movement between said sliding barrel and said tool body; and
an air control device, said air control device comprising a plug mounted in said air inlet of said tool body and adapted to block said air intake when said sliding barrel is moved to said first position, and to open said air inlet for letting a compressed air pass through said air inlet to move said impact unit when said sliding barrel is moved to said second position.

2. The air intake control structure as claimed in claim 1, wherein said air control device is movable in said air inlet by a compressed air.

3. The air intake control structure as claimed in claim 1, wherein said air control device is elastically deformable for letting a compressed air to pass through said air inlet.

4. The air intake control structure as claimed in claim 1, wherein said air control device comprises an air hole extending through said plug.

5. The air intake control structure as claimed in claim 1, wherein the contour of the axial cross section of the air control device has one of the group of shapes including circular shape, T-shape, L-shape, trapezoidal shape, rectangular shape, spherical shape, and annular shape.

6. The air intake control structure as claimed in claim 1, wherein the transverse cross section of said air control device has a top side contour made in one of the group of shapes including arched shape, straight shape, convex shape, and corrugated shape.

7. The air intake control structure as claimed in claim 1, wherein the stop flange of said sliding barrel has a beveled face for stopping against said air control device.

8. The air intake control structure as claimed in claim 7, wherein said plug of said air control device has a beveled face for stopping against the beveled face of said sliding barrel.

9. The air intake control structure as claimed in claim 1, wherein said barrel body of said sliding barrel has an inside hole for accommodating said impact unit, an air hole for receiving compressed air from said air inlet of said tool body, and an air groove formed in said inside hole inside said barrel body for guiding compressed air from the air hole of said barrel body to said impact unit.

10. The air intake control structure as claimed in claim 1, wherein said air control device comprises positioning means; said tool body comprises positioning means for receiving the positioning means of said air control device.
